(19) United States
(12) Patent Application Publication
(10) Pub. No.: US 2026/0038848 A1
(43) Pub. Date: Feb. 5, 2026

(54) Methods of Coating Plates, Plates, and Fuel Cells

(71) Applicant: Robert Bosch GmbH, Stuttgart (DE)

(72) Inventors: Xinlong Xu, Shanghai (CN); Jingjun Zhang, Shanghai (CN); Xu Xie, Shanghai (CN)

(21) Appl. No.: 19/287,492

(22) Filed: Jul. 31, 2025

(30) Foreign Application Priority Data
Aug. 1, 2024 (CN) 2024 1105 4219.X

(51) Int. Cl. H01M 8/0228; H01M 8/0254

(52) U.S. Cl. CPC H01M 8/0228; H01M 8/0254

(57) ABSTRACT

A method of coating a plate, a plate, and a fuel cell are disclosed. The method includes (i) providing a metal plate substrate that includes a plurality of ridges arranged alternately and a plurality of grooves, (ii) applying a photoresist to a plurality of inner surfaces of the plurality of grooves, and (iii) applying a conductive material to a plurality of ridge surfaces of the plurality of ridges. In this manner, by using a photolithography process to apply a photoresist to the grooves and using metal coating technology to apply a conductive material to the ridges, the plates have good corrosion resistance in the groove portion and good conductivity in the ridge portion, while reducing manufacturing costs.

This application claims priority under 35 U.S.C. § 119 to application no. CN 2024 1105 4219.X, filed on Aug. 1, 2024 in China, the disclosure of which is incorporated herein by reference in its entirety.

Embodiments of the present disclosure relate generally to the field of batteries, and more particularly, to plates, fuel cells, and production methods thereof.

### BACKGROUND

In some batteries, a plate is provided for exporting electrical energy from the battery. Plates, for example, are particularly used in proton exchange membrane fuel cells (PEMFCs). PEMFC is a type of hydrogen fuel cell and is commonly used in new energy vehicles. A plurality of fuel cells are typically combined into a fuel cell stack to generate required power. The fuel cell stack includes a plurality of membrane electrodes (MEAs) disposed within the stack and a plurality of bipolar plates (BPPs) disposed between the plurality of MEAs. The bipolar plate may include an anodic side and a cathodic side for adjacent fuel cells within the stack to export power. An anodic gas flow channel is disposed on the anodic side of the bipolar plate, allowing anodic gas to flow to the anodic side of the MEA. A cathodic gas flow channel is disposed on the cathodic side of the bipolar plate, allowing cathodic gas to flow to the cathodic side of the MEA. The bipolar plate may also include a flow channel for cooling fluid.

Bipolar plates are typically made of conductive materials, such as stainless steel, titanium, aluminum, and polymeric carbon composites, to enable them to conduct electricity generated from a fuel cell from one cell to another and export electricity to a fuel cell stack. The application of metal bipolar plates in fuel cells shows significant advantages, such as low cost, ease of manufacture, high mechanical strength, and high power density, but metal corrosion issues severely limit the lifespan of fuel cells.

### SUMMARY

Embodiments of the present disclosure provide a plate having a heterogeneous coating of a photoresist and a conductive material, a and method of producing the same.

A first aspect of the present disclosure relates to a method of producing a plate. The method comprises: providing a metal plate substrate that includes a plurality of ridges arranged alternately and a plurality of grooves; applying a photoresist to a plurality of inner surfaces of the plurality of grooves; and applying a conductive material to a plurality of ridge surfaces.

A second aspect of the present disclosure relates to a method of producing a fuel cell. The method comprises: performing the method of coating a plate according to the first aspect of the present disclosure to obtain a plurality of plates; stacking an end plate, a plurality of membrane electrodes, and the plurality of plates as an initial stack, wherein the plurality of membrane electrodes and the plurality of plates are arranged on a cross-bottom; and processing the initial stack to obtain the fuel cell.

A third aspect of the present disclosure relates to a plate. The plate comprises: a plurality of ridges, including a plurality of ridge surfaces suitable for coupling to a gas diffusion layer; and a plurality of grooves arranged alternately with the plurality of ridges and including a plurality of inner surfaces; wherein the plurality of ridge surfaces are coated with a conductive material and the plurality of inner surfaces are coated with a photoresist.

A fourth aspect of the present disclosure relates to a fuel cell. The fuel cell includes the plate according to the third aspect of the present disclosure.

### BRIEF DESCRIPTION OF THE DRAWINGS

The above and other objectives, features, and advantages of the examples of the present disclosure will become more readily understood by referring to the following detailed description in conjunction with the accompanying drawings. In the drawings, multiple examples of the present disclosure will be described by way of example and not limitation, wherein:

FIG. 1A shows a schematic view of a fuel cell according to an exemplary embodiment of the present disclosure;

FIG. 1B shows an overall schematic diagram of a plate according to an exemplary embodiment of the present disclosure;

FIG. 2 shows a cross-sectional schematic view of a portion of a plate according to an embodiment of the present disclosure;

FIG. 3 shows a schematic flow chart of a method for coating a plate according to an exemplary embodiment of the present disclosure;

FIGS. 4A to 4E show schematic diagrams of a process for coating a plate according to an embodiment of the present disclosure; and

FIGS. 5A to 5B show schematic diagrams of parameters of a plate according to an embodiment of the present disclosure.

### DETAILED DESCRIPTION

The principles of the present disclosure will now be described with reference to various exemplary examples shown in the accompanying drawings. It should be understood that the descriptions of these examples are merely to enable those skilled in the art to better understand and further implement the present disclosure and are not intended to limit the scope of the present disclosure in any way. It should be noted that similar or identical reference numerals may be used in the figures where feasible and similar or identical reference numerals may denote similar or identical functions. Those skilled in the art will readily recognize that alternative examples of the structures and methods described herein can be employed without departing from the principles of the present disclosure as described herein.

As used herein, the term “including” and its variants will be interpreted as an open-ended term meaning “including but not limited to.” The term “based on” will be interpreted as “at least in part based on.” The terms “an example” and “examples” should be understood as “at least one example.” The term “another example” should be understood as “at least one other example.” The terms “first,” “second,” etc. may refer to different or the same objects. Other explicit and implicit definitions may be included below. Unless otherwise explicitly stated, the definitions of terms are consistent throughout the specification.

As discussed above, a plate is typically made of metal. Metal plates produce natural oxides on outer surfaces thereof to make the metal plates corrosion resistant. However, the oxide layer is non-conductive, thus increasing the internal resistance of a fuel cell and reducing the electrical performance of the fuel cell. In addition, the oxide layer typically makes the plate more hydrophobic. However, corrosion of metals severely limits the lifespan of fuel cells, so protective coatings are essential.

In some related technologies, current mainstream coating methods remain vacuum-based deposition technologies, such as chemical vapor deposition (CVD) and physical vapor deposition (PVD). However, these vacuum-based approaches will consume a significant amount of time and cost, resulting in significant restrictions on the large-scale production of metal plates.

In other related technologies, partial coating schemes that do not use a vacuum system are proposed. This approach, rather than using a vacuum system, has features of low cost and fast cycle times. However, in such a design, only the ridges are coated and the groove portions are not. While such a coating may provide contact with a gas diffusion layer and the plate at a lower interface contact resistance (ICR), uncoated channels are directly exposed to corrosion mediums (weakly acidic media), resulting in a significant risk of corrosion. This is because dissolved metal ions reduce proton conductivity, thereby expediting the decomposition of the membrane.

In summary, it can be seen that in relevant technologies, the deposition technology based on vacuum environment is the mainstream coating method, but for large-scale production, the time and cost consumption are too high. At the same time, other coating methods that do not use a vacuum system still cannot guarantee the simultaneous presence of high coating effect conductivity and corrosion resistance.

In view of this, the present disclosure provides a scheme for coating a plate without using a vacuum deposition system. In this scheme, the reaction region of the metal plate substrate includes a groove having a particular geometric shape. The groove consists of a plurality of alternately arranged ridges and grooves, and the ridges come into contact with the electrodes to conduct the current generated by the electrode reaction. The grooves are used to dispense target reactants and products of the fuel cell. The metal plate substrate surface is covered with a coating having a photoresist to prevent corrosion of the metal plate substrate, while the coating of the ridge has a coating that includes a conductive material to conduct the current generated by the electrode reaction. In this manner, by coating the grooves and ridges with different materials, the plates have good corrosion resistance at the groove portions where corrosion resistance is desired and also have good conductivity at the ridge locations where conductivity is desired. The photoresist coating on the groove is made through a photolithography process that can precisely control that the photoresist is applied only to the groove. The conductive material coating on the ridge is applied using a metallic coating process, which greatly reduces time and cost.

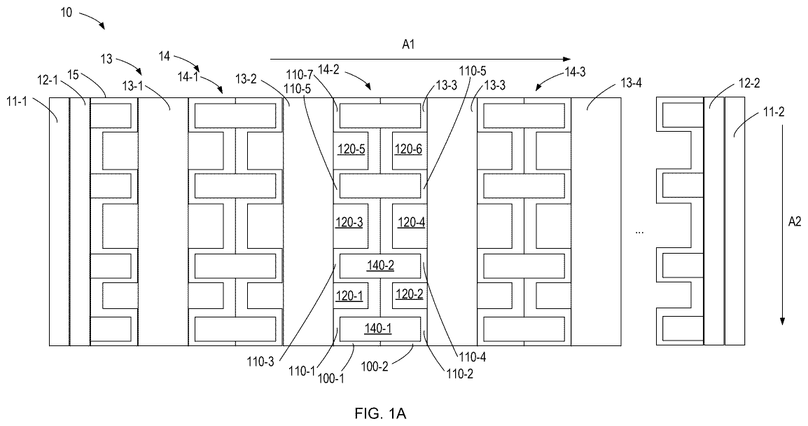

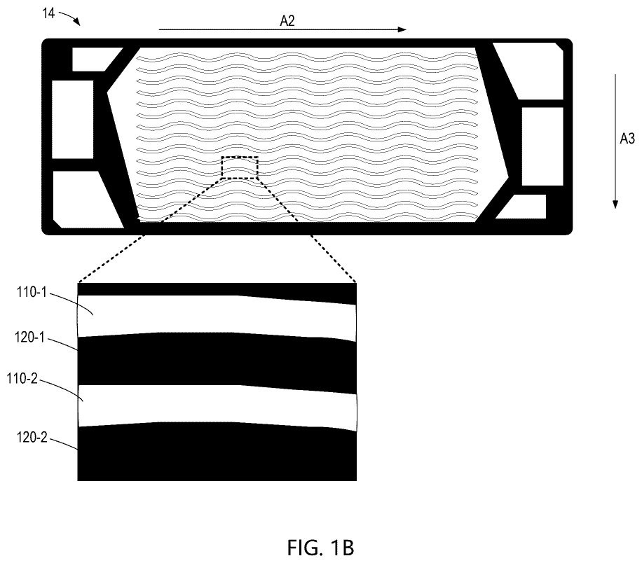

The structure and operating principles of the listening device according to exemplary embodiments of the present disclosure will be described in detail below in conjunction with FIGS. 1 to 5B.

FIG. 1A shows a schematic view of a fuel cell 10 according to an exemplary embodiment of the present disclosure. As shown in FIG. 1A, the fuel cell 10 includes a plurality of plate pieces arranged in a first direction A1. The plurality of plate pieces includes an end plate 11-1, a current collecting plate 12-1, a plurality of membrane electrodes 13 and a plurality of bipolar plates 14 arranged alternately, a current collecting plate 12-2, and an end plate 11-2 arranged in this order. Each plate piece extends in a plane parallel to a second direction A2. A bipolar plate 14-1 of the plurality of bipolar plates 14 is sandwiched between a membrane electrode 13-2 and a membrane electrode 13-1 of the plurality of membrane electrodes 13. Similarly, a bipolar plate 14-2 of the plurality of bipolar plates 14 is sandwiched between the membrane electrode 13-2 and a membrane electrode 13-3 of the plurality of membrane electrodes 13, and a bipolar plate 14-3 of the plurality of bipolar plates 14 is sandwiched between the membrane electrode 13-3 and a membrane electrode 13-4 of the plurality of membrane electrodes 13. Further, the fuel cell 10 further includes a monopole plate 15 sandwiched between the current collecting plate 12-1 and the membrane electrode 13-1. It will be understood that the number of bipolar plates and membrane electrodes shown in FIG. 1A is merely exemplary and that the fuel cell may have a greater or smaller number of bipolar plates and membrane electrodes.

The membrane electrode 13 is a core component of a proton exchange membrane fuel cell consisting of three parts from the inside to the outside: a proton exchange membrane (PEM), a catalyst layer (CL), and a gas diffusion layer (GDL). That is, each membrane electrode 13 includes a proton exchange membrane in the center, catalyst layers arranged symmetrically on both sides of the proton exchange membrane, and gas diffusion layers arranged respectively on one side of the catalyst layer away from the proton exchange membrane.

A proton exchange membrane is a polymeric electrolyte membrane that plays an important role in the fuel cell in conducting protons and isolating cathodic and anodic reactants. It is a core device of the fuel cell and a key component that determines the performance, lifespan, and cost of the fuel cell. In practical applications, proton exchange membranes are required to have high proton conductivity and good chemical and mechanical stability. The catalyst layer may be, for example, a Pt/C catalyst with a perfluorosulfonic acid ionomer (ionomer). The three-phase interface where Pt nanoparticles, ionomers, and gas come into contact is the active site of the catalyst. Here, the surface of the Pt nanoparticles catalyzes hydrogen and oxygen and together with a carbon carrier transfers electrons, while the ionomer transfers hydrogen ions. The primary role of the gas diffusion layer is: carrier of catalyst, motor structure support, electrical conductivity, to evenly diffuse gas, and transport water in the diffusion layer.

The bipolar plate 14 and the monopole plate 15 at an end may both be referred to as a plate, which is used to conduct electrons, distribute reaction gas and assist in the discharge of generated water. From a functional perspective, the plate material is required to be a good conductor of electricity and heat with certain strength and gas tightness. In terms of performance stability, the bipolar plate is required to be corrosion resistant in an acidic, potential, and humid and hot environment of the fuel cell, be compatible with and non-polluting to other components and materials of the fuel cell, and have a certain hydrophobicity to assist in the discharge of water generated by the battery.

As shown in FIG. 1A, the structure of each of the plurality of membrane electrodes 13 is the same and the structure of each of the plurality of bipolar plates 14 is the same as well. Accordingly, the bipolar plate 14-2 will be described in detail below for brevity purposes and without loss of generality. The bipolar plate 14-2 includes a bipolar plate half 100-1 and a bipolar plate half 100-2. The bipolar plate half 100-1 and the bipolar plate half 100-2 are identical in structure. The side of the bipolar plate half 100-1 towards the membrane electrode 13-2 is an end side with a plurality of protruding ridges and grooves located between the ridges. The side of the bipolar plate half 100-1 towards the bipolar plate half 100-2 is a back side coupled to the back side of the bipolar plate half 100-2 towards the bipolar plate half 100-1 to form a coupling portion and a coolant channel. Further, the bipolar plate half 100-1 has the same structure as the monopole plate 15.

In the embodiment shown in FIG. 1A, the bipolar plate half 100-1 includes a ridge 110-1, a ridge 110-3, a ridge 110-5, and a ridge 110-7. The ridge 110-1, the ridge 110-3, the ridge 110-5, and the ridge 110-7 are coated with a conductive material on the ridge surfaces. Ridge 110-7. The ridge 110-1, the ridge 110-3, the ridge 110-5, and the ridge 110-7 are electrically coupled with the cathode of the membrane electrode 13-2 via a conductive material coating. A groove 120-1, a groove 120-3, and a groove 120-5 for conveying water or oxygen are formed between the ridge 110-1 and the ridge 110-3. A photoresist for corrosion resistance is applied on the inner surfaces of the inner walls of the groove 120-1, the groove 120-3, and the groove 120-5.

Correspondingly, the bipolar plate half 100-2 includes a ridge 110-2, a ridge 110-4, a ridge 110-6, and a ridge 110-8. The ridge 110-2, the ridge 110-4, the ridge 110-6, the ridge 110-8 are coated with a conductive material on the ridge surfaces. The ridge 110-2, the ridge 110-4, the ridge 110-6, and the ridge 110-8 are electrically coupled with the anode of the membrane electrode 13-3 via a conductive material coating. A groove 120-2, a groove 120-4, and a groove 120-6 for conveying hydrogen gas are formed between the ridge 110-2 and the ridge 110-4. A photoresist for corrosion resistance is applied on the inner surfaces of the inner walls of the groove 120-2, the groove 120-4, and the groove 120-6.

In some embodiments, fuel cells may also be produced by the following steps. For example, a method of producing a plate according to an embodiment of the present disclosure may be performed first to obtain a plurality of plates. Here, the plurality of plates may include a monopole plate and a bipolar plate. An end plate, a current collecting plate, a plurality of membrane electrodes, and a plurality of plates are then stacked as an initial stack. Here, the plurality of membrane electrodes and the plurality of plates are arranged alternately. Finally, the initial stack is processed to obtain a fuel cell. The processing may include, for example, a compression operation for the initial stack, a tensioning operation for the compressed stack, a leak test for the tensioned stack, a molding assembly, activation, and testing.

FIG. 1B shows an overall schematic view of a bipolar plate 14, consistent with an exemplary embodiment of the present disclosure. The bipolar plate 14 corresponds, for example, to the bipolar plate 14-1, the bipolar plate 14-2, or the bipolar plate 14-3 of FIG. 1A. The bipolar plate 14 extends, for example, in the second direction A2, and is provided on one side, e.g., on an end side, with a plurality of channels and a plurality of grooves arranged alternately on a third direction A3. FIG. 1B also shows a partial enlarged view of a portion of the bipolar plate 14. In the partial enlarged view, the ridge 110-1, the groove 120-1, the ridge 110-2, and the groove 120-2 are arranged in sequence. It can be seen that the grooves and ridges extend in a curved manner in the second direction A2.

In the embodiments shown in FIGS. 1A and 1B, the bipolar plate 14 is produced, for example, by a method for making a plate according to the present disclosure. By coating the inner surface of the groove 120 with a photoresist, it is possible to provide sufficient corrosion resistance and establish good conductive contact with the gas diffusion layer of the membrane electrode by applying a conductive material on the ridge surface of the ridge. It will be understood that FIG. 1B illustrates one half of the bipolar plate 14, which may correspond to the monopole plate 15.

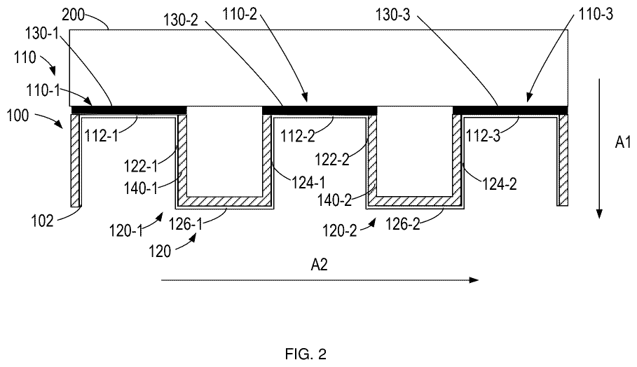

FIG. 2 shows a cross-sectional schematic view of a portion of the plate 100, consistent with an embodiment of the present disclosure. As shown in FIG. 2, the plate 100 may correspond, for example, to the bipolar plate half 100-1, the bipolar plate half 100-2, or the monopole plate 15 shown in FIG. 1A. The plate 100 includes a metal plate substrate 102. The metal plate substrate 102 may be made of, for example, SS316L stainless steel. The metal plate substrate 102 includes a plurality of ridges 110 and a plurality of grooves 120. The plurality of ridges 110 includes ridges 110-1, 110-2, and 110-3. A groove 120-1 is disposed between the ridges 110-1 and 110-2 and a groove 120-2 is disposed between the ridges 110-2 and 110-3.

The plate 100 is electrically coupled to the gas diffusion layer 200 through the ridges 110-1, 110-2, and 110-3. The ridge 110-1 includes a ridge surface 112-1 towards the gas diffusion layer 200. On the ridge surface 112-1, a conductive material coating 130-1 is applied. Accordingly, the ridge 110-2 include a ridge surface 112-2 towards the gas diffusion layer 200 and a conductive material coating 130-2 is applied to the ridge surface 112-2. The ridge 110-3 includes a ridge surface 112-3 towards the gas diffusion layer 200. A conductive material coating 130-3 is applied to the ridge surface 112-3.

The channel 120-1 includes a first sidewall 122-1 extending from the ridge 110-1 in a direction parallel to the first direction A1 and away from the ridge 110-1. The groove 120-1 also includes a second sidewall 124-1 extending from the ridge 110-2 in a direction parallel to the first direction A1 and away from the ridge 110-2. Further, the groove 120-1 also includes a bottom 126-1 that bridges the first sidewall 122-1 and the second sidewall 124-1. Correspondingly, the groove 120-2 includes a first sidewall 122-2 that extends from the ridge 110-2 in a direction parallel to the first direction A1. The groove 120-2 also includes a second sidewall 124-2 extending from the ridge 110-3 in a direction parallel to the first direction A1. Further, the groove 120-2 also includes a bottom 126-2 that bridges the first sidewall 122-2 and the second sidewall 124-2.

On the inner surface of the groove 120-1, a photoresist coating 140-1 is applied to a surface of the first sidewall 122-1 towards the second sidewall 124-1, a surface of the second sidewall 124-1 towards the first sidewall 122-1, and a surface of the bottom 126-1 towards the ridge. On the inner surface of the groove 120-2, a photoresist coating 140-2 is applied to a surface of the first sidewall 122-2 towards the second sidewall 124-2, a surface of the second sidewall 124-2 towards the first sidewall 122-2, and a surface of the bottom 126-2 towards the ridge.

In the embodiment shown in FIG. 2, the conductive material coating 130-1 is connected with the photoresist coating 140-1 at the connection of the ridge surface 112-1 and the first sidewall 122-1. At the same time, the conductive material coating 130-2 is connected with the photoresist coating 140-1 at the connection of the ridge surface 112-2 and the second sidewall 124-1. As such, by similar configuration, the photoresist coating and the conductive material coating are connected and fully cover one side of the metal plate substrate 102. In some embodiments, the back side of the metal plate substrate 102 may also be coated with a corresponding coating as desired to provide corresponding functions, such as corrosion resistance and conductivity.

In the embodiment shown in FIG. 2, by applying a corrosion resistant coating on the inner surface of the plate groove, it is possible to improve the lifespan of the plate, while the conductive material coating of the ridge in contact with the gas diffusion layer simultaneously plays a dual role in reducing the contact resistance between the plate and the membrane electrode and improving the corrosion resistance of the plate.

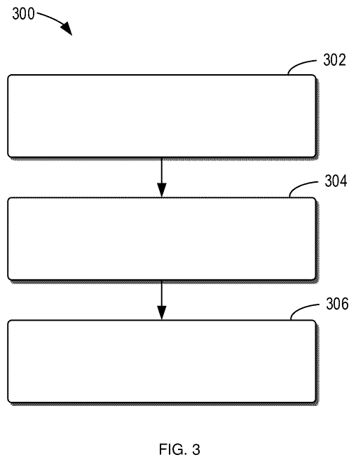

FIG. 3 shows a schematic flow chart of an example method 300 for producing a plate, consistent with an exemplary embodiment of the present disclosure. For purposes of discussion, the method 300 will be described in conjunction with the embodiment shown in FIG. 2. The method 300 may be performed, for example, by a production line or system for producing a plate.

As shown in FIG. 3, at 302, a metal plate substrate is provided. Here, the metal plate substrate includes a plurality of ridges arranged in an alternating manner and a plurality of grooves. For example, in the embodiment shown in FIG. 2, a stamped and cleaned stainless steel metal plate substrate 102 may be provided. The metal plate substrate 102 includes a plurality of ridges 110 and a plurality of grooves 120.

At 304, a plurality of inner surfaces of the plurality of grooves 120 are coated with a photoresist. For example, in the embodiment shown in FIG. 2, an appropriate photoresist coating manner may be utilized to apply the photoresist to the surfaces of the first sidewall 122-1, the second sidewall 124-1, the bottom 126-1, and the first sidewall 122-2, the second sidewall 124-2, and the bottom 126-2.

In some embodiments, the coating process may comprise preparing a first slurry comprising a photoresist. The photoresist in the first slurry may have different concentrations or viscosities corresponding to different coating methods. Thereafter, the coating process includes applying the first slurry to an entire side of the metal plate substrate suitable for coupling to the membrane electrode to form a coating layer including a photoresist on the entire side using one of: spray coating, dip coating, or flow coating. The side includes a plurality of ridged surfaces and a plurality of inner surfaces. Here, the first slurry layer may be applied over the entire side of the metal plate substrate 102 to be coated using spray coating, dip coating, or flow coating. Finally, the coating process includes removing the coating layer on the plurality of ridge surfaces. Here, the coating layer formed is primarily a photoresist.

For example, in the embodiment shown in FIG. 2, the first slurry may be applied to the surfaces of the ridge surface 112-1, the ridge surface 112-2, the ridge surface 112-3, and the first sidewall 122-1, the second sidewall 124-1, the bottom 126-1, and the first sidewall 122-2, the second sidewall 124-2, and the bottom 126-2. In some embodiments, the photoresist may be a positive photoresist or a negative photoresist. The positive photoresist may be, for example, an AZ4620 photoresist. The negative photoresist may be SU-8 photoresist.

Upon removal of the coating layer on the plurality of ridge surfaces, e.g., in embodiments of a positive photoresist, the photoresist on the ridge surface may be exposed, and then the exposed photoresist may be dissolved using a developer. In contrast, in the embodiment of the negative photoresist, the photoresist on the inner surface of the groove other than the ridge surface may be exposed, and then the unexposed photoresist on the ridge surface may be dissolved using the developer. Here, the developer is, for example, a base solution, such as potassium hydroxide and potassium carbonate. Here, because the coating layer is composed primarily of a photoresist, the coating layer that is reacted by the developer may be completely removed upon modification of the photoresist.

At 306, a conductive material is applied to the plurality of ridge surfaces. For example, in the embodiment shown in FIG. 2, a conductive material may be applied over the ridge surface from which a photoresist has been removed by roll coating to form a conductive material coating on the ridge surface. In some embodiments, the process of applying the conductive material may include preparing a second slurry. The second slurry includes a conductive material, an adhesive, and a solvent mixed at a certain ratio. The process of applying the conductive material further includes applying the second slurry to the plurality of ridge surfaces to form a conductive coating using one of: roll coating, transfer printing, or screen printing.

In some embodiments, the process of roll coating may include evenly applying the second slurry to a roller surface of a roller coating device. The roller coating device may include, for example, an upper roller for loading and a lower roller for uniform coating. The process of roll coating also includes moving the metal plate substrate to make the plurality of ridge surfaces contact with the roller such that the plurality of ridge surfaces are coated with the second slurry, thereby forming a second slurry layer. For example, a metal plate substrate coated with a photoresist may be placed on a conveying device of a roller coating device to move under the drive of the conveying device to come into contact with the roller. Finally, the process of roll coating further includes drying the second slurry layer to obtain the conductive coating.

In some alternative embodiments, the process of transfer printing may include applying the second slurry on a base film to form a second slurry layer. The process of transfer printing also includes drying the second slurry layer. The process of transfer printing finally includes transfer printing the second slurry layer from the base film to the plurality of ridge surfaces.

In the embodiment shown in FIG. 3, by applying the photoresist by spray coating, dip coating or flow coating, and applying the conductive material by roll coating, transfer printing or screen printing, the use of vacuum environment-based coating solutions is avoided, thereby greatly saving time and cost.

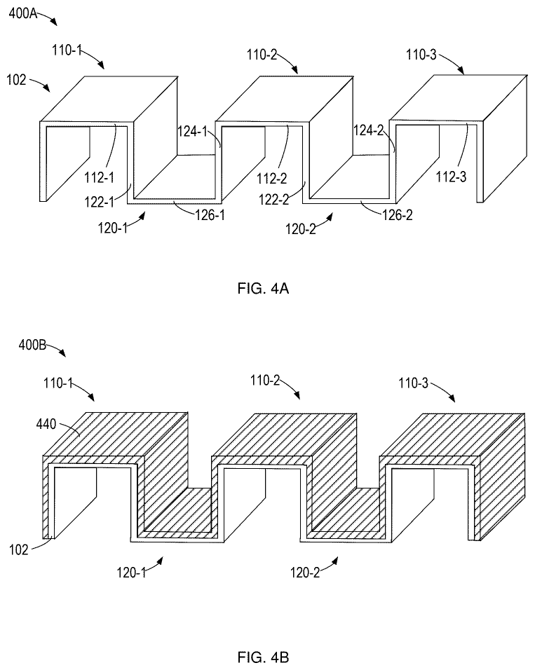

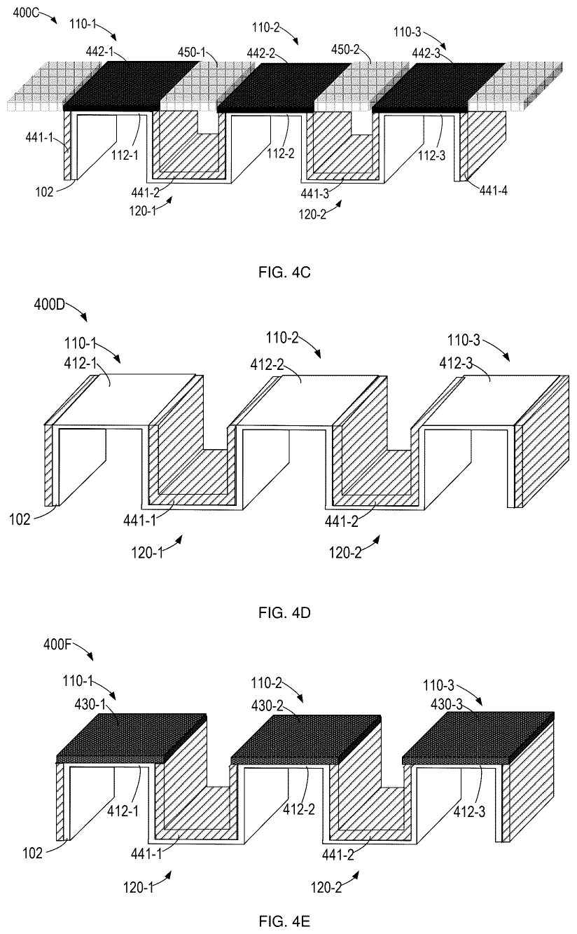

FIG. 4A shows a schematic diagram of a step 400A of providing a plate, consistent with an embodiment of the present disclosure. As shown in FIG. 4A, in step 400A, a metal plate substrate 102 is provided. In some embodiments, the metal plate substrate 102 may be made, for example, of SS316L stainless steel. The metal plate substrate 102 includes a plurality of ridges 110 and a plurality of grooves 120. The plurality of ridges 110 include a ridge 110-1, a ridge 110-2, and a ridge 110-3. A groove 120-1 is disposed between the ridges 110-1 and 110-2 and a groove 120-2 is disposed between the ridges 110-2 and 110-3.

The ridge 110-1 includes a ridge surface 112-1 suitable for coupling to the gas diffusion layer. The ridge 110-2 includes a ridge surface 112-2 suitable for coupling to the gas diffusion layer. The ridge 110-3 includes a ridge surface 112-3 suitable for coupling to the gas diffusion layer. The groove 120-1 includes a first sidewall 122-1 extending from the ridge 110-1 in a direction away from the ridge 110-1. The groove 120-1 also includes a second sidewall 124-1 extending from the ridge 110-2 in a direction away from the ridge 110-2. Further, the groove 120-1 further includes a bottom 126-1 that bridges the first sidewall 122-1 and the second sidewall 124-1. Accordingly, the groove 120-2 includes a first sidewall 122-2 extending from the ridge 110-2 in a direction away from the ridge 110-2. The groove 120-2 also includes a second sidewall 124-2 extending from the ridge 110-3 in a direction away from the ridge 110-3. Further, the groove 120-2 also includes a bottom 126-2 that bridges the first sidewall 122-2 and the second sidewall 124-2.

In the embodiment shown in FIG. 4A, the metal plate substrate 102 is stamped and flushed clean so that further steps can be taken.

FIG. 4B shows a schematic diagram of a step 400B of applying a photoresist, consistent with an embodiment of the present disclosure. In step 400B, the metal plate substrate 102 may be placed, for example, on a support station of a system for producing the plate to cause the plurality of ridge surfaces 112 to face towards a nozzle for spraying the photoresist. Thereafter, the metal plate substrate 102 is heated to a predetermined temperature specific to the photoresist. The heating can accelerate the volatilization of the solvent of the photoresist droplets after covering the metal plate substrate 102, so that the fluidity of the photoresist is reduced to the minimum, so as to cover the surface of the metal plate substrate 102 facing the nozzle and the surface of the bend. The photoresist is uniformly sprayed with a nozzle over a plurality of ridge surfaces and a plurality of inner surfaces to form a monolithic photoresist coating 440. It will be understood that the photoresist coating corresponds to the coating layer previously described that includes the photoresist, and the two can be replaced with one another.

The thickness of the formed photoresist coating 440 may range, for example, from 100 nanometers to 100 microns. The thickness of the photoresist coating 440 may, for example, be 10 microns. Because the grooves require a water or gas guide, its most important feature is that it is corrosion resistant. Corrosion resistance in turn is closely related to the thickness of the coating. Therefore, the thickness of the coating should be as thin as possible, provided that the corrosion resistance requirements are met. As a result, greater volume of water guide can be provided.

In this step, the nozzle can be made to perform an S-shaped scan relative to the ridge surface and the inner surface of the metal plate substrate 102, thereby traversing all the ridge surfaces and the inner surface of the metal plate substrate 102, so that the entire end surface of the metal plate substrate 102 is evenly covered with photoresist.

In some embodiments, after traversing once, the angle may be changed or the route relative to the metal plate substrate 102 may be changed to traverse at least once more. As the directions of the inner surfaces are different, spray coating is performed again after changing the angle or route to traverse the end side of the metal plate substrate 102 so that each direction can be covered with a sufficient thickness of the photoresist coating 440.

In some embodiments, after spray coating is completed, the photoresist coating 440 may also be baked at a certain temperature to remove most of the solvent therein and cure the photoresist to form a thin film with a certain rigidity.

FIG. 4C shows a schematic diagram of a step 400C of removing a photoresist, consistent with an embodiment of the present disclosure. In step 400C, a mask 450-1 is covered over an opening of the groove 120-1 and a mask 450-2 is covered over an opening of the groove 120-2 to form an exposure region 442-1 on the ridge surface 112-1, an exposure region 442-2 on the ridge surface 112-2, and an exposure region 442-3 on the ridge surface 112-3. The exposure region 442-1, the exposure region 442-2, and the exposure region 442-3 are then illuminated with ultraviolet light to modify the photoresist on the exposure region.

In embodiments utilizing contact exposure, the exposure light source is a mercury light or an LED, which may emit ultraviolet light. Ultraviolet light is shaped by optical path adjustment to form approximately parallel light of a certain area, and is irradiated onto the mask and exposure regions. When ultraviolet light is irradiated onto the photoresist coating on the exposure region, the photoresist at that location undergoes a photosensitivity reaction.

Photosensitive materials in the photoresist have photosensitivity of absorbing light energy or other radiation energy. When exposed to ultraviolet light, electron beam, ion beam, X-ray and other radiation, the solubility and affinity of the photosensitive resin of the photoresist change due to the light curing reaction. After an appropriate solvent treatment, the soluble part can be dissolved to obtain a desired image. Thus, once the photoresist on the exposure region is irradiated by the ultraviolet light, the photoresist can be removed.

FIG. 4D shows a schematic diagram of a step 400D of clearing a photoresist, consistent with an embodiment of the present disclosure. In step 400D, the exposed photoresist coating is subjected to wet chemical treatment to selectively remove the photoresist located on the ridge surface. In the embodiment shown in FIG. 4D, the photoresist is a positive photoresist, and the principle of performing a “development” operation on the photoresist is that the dissolution rate of the exposed photoresist coating in a weak basic solution increases by two to three orders of magnitude. Thus, with the action of a weak basic developer, the photoresist on the exposed ridge surface can be dissolved rapidly, while the dissolution rate of the photoresist on the unexposed inner surface is very low, thereby allowing it to remain on the inner surface. Upon removal of the photoresist from the exposure region, a ridge surface 412-1, a ridge surface 412-2, and a ridge surface 412-3 with photoresists removed are formed at the ridge. At the same time, a photoresist coating 441-1 on the inner surface is formed in the groove 120-1 and a photoresist coating 441-2 on the inner surface is formed in the groove 120-2.

In some embodiments, the “development” operation may be steeping development, spin spray development, and infiltrating development. In some embodiments, the metal plate substrate 102 may be baked to further evaporate residual solvent and other volatile organic matter after the development operation.

FIG. 4E shows a schematic diagram of a step 400F of applying a conductive material, consistent with an embodiment of the present disclosure. In step 400F, a metal plate substrate 102 having a ridge surface 412-1, a ridge surface 412-2, and a ridge surface 412-3 having a photoresist thereon removed is placed on a conveying device of a roll coating device. Thereafter, the conveying device is operated to contact the ridge surface 412-1, the ridge surface 412-2, and the ridge surface 412-3 with the rollers of the roll coating device such that the ridge surface 412-1, the ridge surface 412-2, and the ridge surface 412-3 are coated with a second slurry on the rollers. The second slurry, for example, comprises an electrically conductive agent, a bonding agent, and a solvent. After drying, the solvent will be completely volatilized. The parameter that determines the conductive performance of the conductive material coating is the ratio between the conductive agent and the bonding agent. The ratio shall ensure that the resistance of the conductive material coating is as small as possible while ensuring the tightness of the conductive material layer. For example, in some embodiments, the ratio between the conductive agent and the bonding agent results in a contact resistance of the lastly formed conductive material coating under a pressure of 1.4 MPa of less than 100 mΩ cm², in particular less than 10 mΩ cm². As such, a conductive material coating 430-1 is formed on the ridge surface 412-1, a conductive material coating 430-2 is formed on the ridge surface 412-2, and a conductive material coating 430-3 is formed on the ridge surface 412-3.

In the embodiments shown in FIGS. 4A to 4E, the spray coating process for the coating of the photoresist and the roll coating process for the coating of the conductive material have low requirements for the execution environment and equipment, and are suitable for large scale production with short manufacturing cycles, thereby greatly reducing manufacturing time and manufacturing costs.

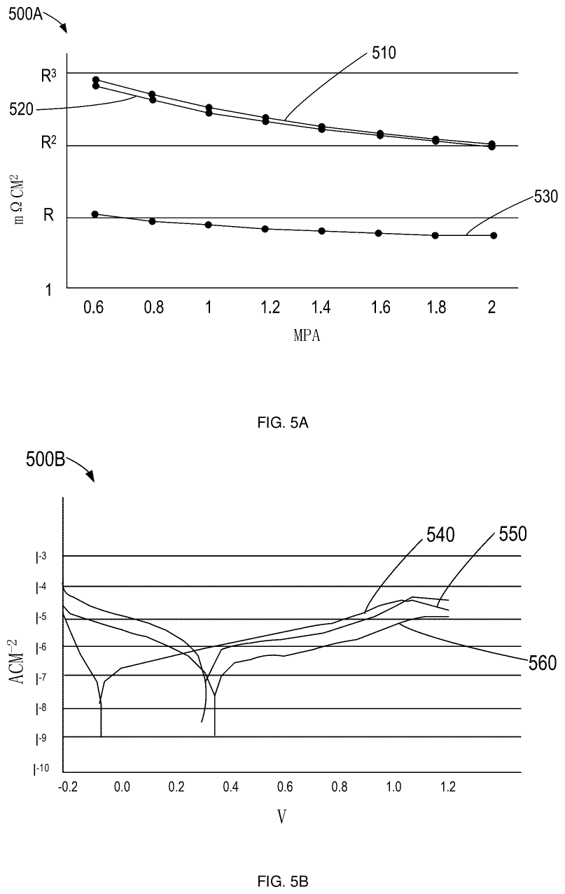

FIG. 5A shows a schematic graph 500A of a contact resistance of a plate with respect to a pressure, consistent with an embodiment of the present disclosure. As shown in FIG. 5A, the graph 500A includes 3 curves of contact resistance with respect to a pressure, namely, a curve 510 corresponding to Comparative Example 1, a curve 520 corresponding to Comparative Example 2, and a curve 530 corresponding to a metal plate obtained using an application method according to an embodiment of the present disclosure. Here, the metal plate in Comparative Example 1 is a completely uncoated plate with contact resistance beginning to decrease as the pressure increases from approximately R³ mΩ cm² at 0.6 MPA. The metal plates in Comparative Example 2 is a plate having a photoresist coating in the grooves but no conductive material coating in the ridges, and its contact resistance starts to decrease as the pressure increases, starting from a resistance at 0.6 MPA, which is slightly lower than the resistance in the Comparative Example 1 but close to R³ mΩ cm². The resistance of the plate of the embodiment of the present disclosure begins to decrease as the pressure increases from approximately R mΩ cm² at 0.6 MPA.

Here, the contact resistance of the plate of embodiment of the present disclosure may be at most two orders of magnitude smaller than a plate that does not utilize the scheme of the present disclosure. Thus, the conductive coating of the ridges can significantly reduce the contact resistance, demonstrating a significant increase in conductivity.

FIG. 5B shows a schematic graph 500B of a current density of a plate with respect to potential, consistent with an embodiment of the present disclosure. As shown in FIG. 5B, the graph 500B includes 3 curves of current density with respect to potential, namely, a curve 540 corresponding to Comparative Example 1, a curve 550 corresponding to Comparative Example 2, and a curve 560 corresponding to a metal plate obtained using an application method according to an embodiment of the present disclosure. Here, the metal plate in Comparative Example 1 is a plate that is completely uncoated with a maximum current density when the potential is greater than 0.4 V. The metal plates in Comparative Example 2 is a plate having a conductive material coating on the ridges but no photoresist coating in the grooves, and the current density thereof is slightly lower than that in Comparative Example 1 after the potential exceeds 0.4 V. The current density of the plates of the embodiment of the present disclosure is minimal after the potential is greater than 0.4 V, approximately less than one order of magnitude of the other two examples. Thus, the coating of the groove can significantly reduce the corrosion current, demonstrating a significant increase in corrosion resistance.

While the claims in the present application have been formulated with respect to particular combinations of features, it should be understood that the scope of the present disclosure also includes any novel combination of any novel features or features disclosed herein expressly or implicitly, or as any generalization thereof, whether or not it relates to the same scheme in any of the claims currently claimed.

What is claimed is:

1. A method of coating a plate, comprising:
providing a metal plate substrate that includes a plurality of ridges arranged alternately and a plurality of grooves;
applying a photoresist to a plurality of inner surfaces of the plurality of grooves, the grooves including two sidewalls connected to the ridges and a bottom connecting the two sidewalls, the inner surface including surfaces of the two sidewalls and the bottom within the groove; and
applying a conductive material to a plurality of ridge surfaces of the plurality of ridges.

2. The method according to claim 1, wherein applying the photoresist to the plurality of inner surfaces of the plurality of grooves comprises:
preparing a first slurry comprising the photoresist;
applying the first slurry to an entire side of the metal plate substrate suitable for coupling to a membrane electrode to form a coating layer including the photoresist using one of: spray coating, dip coating, or flow coating, wherein the side includes the plurality of ridge surfaces and the plurality of inner surfaces; and
removing the coating layer on the plurality of ridge surfaces.

3. The method according to claim 2, wherein applying the first slurry on the side by spray coating comprises:
immobilizing the metal plate substrate;
spraying the first slurry on the side to obtain the coating layer with a predetermined thickness; and
drying the coating layer to solidify a photoresist in the coating layer.

4. The method according to claim 3, wherein the predetermined thickness is 100 nanometers to 100 microns.

5. The method according to claim 2, wherein removing the coating layer on the plurality of ridge surfaces comprises:
disposing a mask over a plurality of openings of the plurality of grooves to form an exposure region on the plurality of ridge surfaces;
illuminating the exposure region with ultraviolet light to modify a photoresist on the exposure region; and
dissolving the coating layer on the exposure region with a developer.

6. The method according to claim 1, wherein applying a conductive material to the plurality of ridge surfaces comprises:
preparing a second slurry including the conductive material, an adhesive, and a solvent; and
applying the second slurry to the plurality of ridge surfaces using one of the following to form a conductive coating: roll coating, transfer printing, or screen printing.

7. The method according to claim 6, wherein applying the second slurry to the plurality of ridge surfaces using a roll coating method comprises:
evenly applying the second slurry to a roller surface of a roller coating device;
moving the metal plate substrate to make the plurality of ridge surfaces in contact with the roller such that the plurality of ridge surfaces are coated with the second slurry, thereby forming a second slurry layer; and
drying the second slurry layer to obtain the conductive coating.

8. The method according to claim 6, wherein applying the second slurry to the plurality of ridge surfaces by way of a transfer printing comprises:
applying the second slurry to a base film to form a second slurry layer;
drying the second slurry layer; and
transfer printing the second slurry layer from the base film to the plurality of ridge surfaces.

9. The method according to claim 6, wherein a ratio of the conductive material and the adhesive is set such that the conductive coating is less than 100 mΩ per square centimeter at 1.4 MPa.

10. A method of producing a fuel cell, comprising:
performing the method of coating a plate according to claim 1 to obtain a plurality of plates;
stacking an end plate, a plurality of membrane electrodes, and the plurality of plates as an initial stack, wherein the plurality of membrane electrodes and the plurality of plates are arranged on a cross-bottom; and
processing the initial stack to obtain the fuel cell.

11. A plate having a coating, comprising:
a plurality of ridges, including a plurality of ridge surfaces configured to couple to a gas diffusion layer; and
a plurality of grooves arranged alternately with the plurality of ridges and including a plurality of inner surfaces and configured to house hydrogen gas, air, or water,
wherein the plurality of ridge surfaces are coated with a conductive material and the plurality of inner surfaces are coated with a photoresist.

12. The plate according to claim 11, wherein the conductive material and the photoresist are coated by a method comprising:
providing a metal plate substrate that includes a plurality of ridges arranged alternately and a plurality of grooves;
applying a photoresist to a plurality of inner surfaces of the plurality of grooves, the grooves including two sidewalls connected to the ridges and a bottom connecting the two sidewalls, the inner surface including surfaces of the two sidewalls and the bottom within the groove; and
applying a conductive material to a plurality of ridge surfaces of the plurality of ridges.

13. A fuel cell comprising the plate according to claim 11.
